(19) United States
(12) Patent Application Publication
(10) Pub. No.: US 2026/0326112 A1
(43) Pub. Date: Oct. 22, 2026

(54) CUTTING TOOL

(71) Applicant: PRINOTH GmbH, Herdwangen (DE)

(72) Inventors: Daniel BRAUN, Radolfzell (DE); Markus HOSTI, Stockach (DE)

(21) Appl. No.: 19/649,366

(22) Filed: Apr. 16, 2026

(30) Foreign Application Priority Data
Apr. 17, 2025 (DE) 10 2025 115 308.6

(51) Int. Cl. B02C 18/18; B27L 11/00

(52) U.S. Cl. CPC B02C 18/18; B27L 11/005

(57) ABSTRACT

A cutting tool for a comminuting rotor, in particular for a comminution of wood and/or soil, the cutting tool having a base body and having at least one cutting edge and at least one fastening region that is formed by the base body and is preferably realized at least partly as a fastening hollow, the fastening region including a lower subregion and a rear subregion which are oriented at an angle to one another, wherein the rear subregion is formed by a groove having a flat contact surface and lateral flanks which are configured, in an assembled state, to engage around a correspondingly realized contact region.

### CROSS-REFERENCE TO RELATED APPLICATION

As a U.S. follow-up application, this patent application is based on and claims priority to German patent application DE 10 2025 115 308.6, filed on Apr. 17, 2025, the contents of which are incorporated herein by reference.

### Prior Art

The invention concerns a cutting tool.

A cutting tool for a comminuting rotor, in particular for a comminution of wood and/or soil, having a base body and having at least one cutting edge and at least one fastening region that is formed by the base body and is preferably realized at least partly as a fastening hollow, the fastening region comprising a lower subregion and a rear subregion which are oriented at an angle to one another, has already been proposed.

The objective of the invention is in particular to provide a generic device with improved characteristics regarding compactness, in terms of production costs and of simple exchangeability. The objective is achieved according to the invention.

### Advantages of the Invention

The invention is based on a cutting tool for a comminuting rotor, in particular for a comminution of wood and/or soil, having a base body and having at least one cutting-edge and at least one fastening region that is formed by the base body and is preferably realized at least partly as a fastening hollow, the fastening region comprising a lower subregion and a rear subregion which are oriented at an angle to one another.

It is proposed that the rear subregion is formed by a groove having a flat contact surface and lateral flanks which are configured, in an assembled state, to engage around a correspondingly realized contact region.

A “cutting tool” is in particular to mean a unit configured for comminuting, in particular cutting and/or chopping and/or fragmenting, material, in particular wood and/or soil, in particular also rock. In particular, the cutting tool is configured to be fastened to a base element of a cutting system, which is connected to the comminuting rotor. Preferably, the cutting tool can be fastened to the base element exchangeably. Preferably, the cutting tool can be mounted to a base element via a connection that is preferably releasable without destruction. Preferably, the cutting tool can be connected to the base element by means of a screw connection. A “cutting tool” is preferably to mean a unit having at least one cutting edge. In an operation state, the cutting tool absorbs forces acting on the cutting edge and/or dissipates them. Preferably, the cutting tool can be realized by a base body having a cutting-edge receptacle in which a cutting edge, for example a hardened cutting edge, in particular a cutting edge made of a hard metal, is connected. Preferably, a cutting edge is connected to a cutting-edge receptacle of the base body of the cutting tool by a soldered connection. In principle, it would also be conceivable that the cutting edge is fixedly connected to the cutting-edge receptacle of the base body by a welded connection. Preferably, it is likewise conceivable that the cutting edge is connected to the base body by means of another connection method. In principle, it is also conceivable that the cutting edge is realized integrally with a base body of the cutting tool. If the cutting edge is realized integrally with the base body of the cutting tool, the entire cutting tool is formed integrally from a single component, preferably as a forged part.

By a “fastening region” is preferably a region to be understood via which the cutting tool can be fastened to a correspondingly realized base element. The fastening region forms a contact surface with which the cutting tool bears against a correspondingly realized contact region of the base element. Preferably, the fastening region is realized at least partly, that is to say at least in a portion, as a fastening hollow. Preferably, the fastening region is realized in at least one of the two subregions at least section-wise, preferably completely, as a fastening hollow. By a “rear subregion” is preferably a subregion of the fastening region to be understood which is arranged at least partly on a rear side of the base body of the cutting tool. In principle, it is also possible that the rear subregion is arranged at least partly on an underside of the base body of the cutting tool. The rear subregion is formed by a groove that is introduced in the rear side of the base body of the cutting tool. Preferably, the groove has been milled into the rear side of the base body. In principle, it would also be conceivable for the groove that forms the rear subregion to be realized at least partly or completely in a non-machined manner. Preferably, it would herein be conceivable for the groove that forms the rear subregion of the fastening region to be introduced in the base body of the cutting tool in a forging process. The groove that forms the rear subregion could form a non-machined forged surface. In principle, it would be conceivable that both the flanks and a contact surface of the groove are non-machined, that is to say they form a non-machined forged surface. In principle, it would also be conceivable that only the contact surface or the flanks are at least partly, preferably completely, machined, for example milled. The groove has a planar contact surface. The contact surface is realized as a groove bottom of the groove. The contact surface is configured to flatly, planarly adjoin a corresponding surface of a contact region of the base element. The groove has lateral flanks which laterally delimit the contact surface. The flanks are configured, in an assembled state, to enclose a contact region of the base element at least in a subregion. The flanks are configured for a form-fitting positioning and support of the cutting tool on the base element. A corresponding contact region is formed by a base element to which the cutting tool is fastened exchangeably. The contact region is a corresponding subregion of a contact region of the base element.

A “lower subregion” is preferably to mean a subregion of the fastening region which is formed at least to a large extent by an underside of the base body of the cutting tool. The subregion has a contact surface, in particular side surfaces, by which the subregion rests on a corresponding subregion of a contact region of the base element. Preferably, the lower subregion is at least partly non-machined. Preferably, the lower subregion of the fastening region is realized as a wedge-shaped groove. In principle, it would also be conceivable that the lower subregion is realized as a planar surface. In principle, it would herein also be conceivable that the lower subregion does not form a wedge-shaped groove. “At an angle to one another” is preferably to mean that longitudinal extension axes of the two subregions are arranged at an angle A with respect to one another and are not oriented parallel to one another. The angles between two subregions are preferably measured between two main extension planes of the respective subregions. If the subregions each have a planar bottom, the angle A between the subregions can preferably be measured between the respective bottoms which are realized, for example, by grooves. The angle A by which the two subregions of the fastening region are arranged at an angle to one another is preferably between 95 degrees and 120 degrees, preferably between 100 degrees and 115 degrees. Preferably, the lower subregion and the rear subregion of the fastening region enclose an angle A of 110 degrees with one another. The cutting tool and preferably also the base element are preferably realized as forged parts. Forged parts produced in a forging process have tolerances that must be taken into account, in particular with respect to angle specifications. The angles between non-machined surfaces specified above and in the following are always to be understood as designed angles with which the cutting tool and/or the base element were designed. Due to the respective tolerances, in a correspondingly produced component an angle relative to a non-machined surface may deviate by up to 2 degrees. A corresponding contact region is formed by a base element to which the cutting tool is fastened exchangeably. The contact region is a corresponding subregion of a contact region of the base element. A contact region is thus to mean a mounting region of the base element, to which a cutting tool is fastened exchangeably, preferably via a screw connection. “Configured” is in particular to mean specially designed and/or equipped. By an object being configured for a specific function is in particular to be understood that the object fulfils and/or performs this specific function in at least one application state and/or operation state.

An implementation according to the invention advantageously allows providing a cutting tool that is especially robust and can be mounted to a base element in a particularly simple manner. Particularly preferably, forces acting on the cutting tool during operation can be dissipated into the base element in an especially favorable manner. The implementation according to the invention allows providing an, in particular long-life, cutting tool. In particular, easy assembly and disassembly are also achievable by the cutting tool according to the invention.

It is further proposed that the lateral flanks each have an angle of 70 degrees to 110 degrees, preferably of 90 degrees, with the planar contact surface. In principle, it would also be conceivable that the lateral flanks are, at least in a subregion, realized in a curved manner. As a result, the rear subregion of the fastening region can be realized especially advantageously for supporting laterally acting forces.

It is moreover proposed that the lower subregion and the rear subregion of the fastening region include an angle A of 20 degrees to 120 degrees, preferably of 50 degrees to 100 degrees, and especially preferably of 70.25 degrees with one another. As a result, the fastening region can be implemented in an especially advantageous fashion in order to achieve an especially advantageous support of forces occurring during operation.

Furthermore, it is proposed that the cutting tool has a fastening-hole longitudinal axis, wherein the rear subregion includes an angle β with the fastening-hole longitudinal axis that is between 40 degrees and 100 degrees, preferably between 50 degrees and 90 degrees, and is particularly preferably 70.5 degrees. A “fastening-hole longitudinal axis” is preferably to mean a middle axis of a fastening hole that is introduced in the cutting tool, in particular in the base body of the cutting tool. A fastening hole is preferably to mean a hole via which the cutting tool can be fixed on a base element in a positionally fixed fashion. The fastening hole preferably has a round cross section. The fastening hole is preferably realized as a bore. Preferably, the fastening hole is configured such that a fastening means configured for a fixing of the cutting tool is at least partly guided through the fastening hole and/or is fastened therein. The fastening hole preferably has an inner thread. The inner thread of the fastening hole preferably extends only over a portion of the length of the fastening hole, as a result of which costs can be saved. The inner thread preferably does not extend over the entire length of the fastening hole. Preferably, the fastening hole that has an inner thread is configured such that a fastening means, for example a screw, for a connection of the cutting tool to a base element is screwed into the fastening hole. The fastening hole introduced in the cutting tool is preferably realized as a blind hole. In principle, however, it would also be conceivable that the fastening hole is realized as a through-hole. As a result, the fastening region can be realized in an especially advantageous manner and an especially advantageous support of operating forces can be brought about. As a result, the cutting tool can advantageously be realized in an especially simple and cost-effective manner, and quick and secure assembly/disassembly of the cutting tool can be achieved. Advantageously, secure fastening of the cutting tool to a base element is also achievable.

It is also proposed that the cutting tool has a fastening-hole longitudinal axis, wherein the lower subregion has an angle B of less than 3 degrees, preferably of less than 1 degree, with respect to the fastening-hole longitudinal axis. Preferably, the angle B is 0.25 degrees. In this way, the lower subregion can be realized especially advantageously in such a way that during mounting to the base element, the cutting tool is pulled into the contact region of the base element and is thus tensioned. As a result, an especially secure connection of the cutting tool to the base element is achievable.

Beyond this, it is proposed that the lower subregion is realized in a V-shaped manner and has an angle E that is between 150 degrees and 180 degrees, and is preferably 169.5 degrees. As a result, the lower subregion can be realized in an especially advantageous manner.

It is further proposed that the base body is realized as a forged part, wherein the lower subregion is at least substantially non-machined. By “at least substantially non-machined” is preferably to be understood that at least a subregion is free from machining, for example machining by a milling machine, and the surface is realized in the manner it is present after the forging operation. As a result, the cutting tool can be realized in a particularly cost-effective and simple manner.

Beyond this, it is proposed that the rear subregion is realized as a main support region, which has a greater extent than the lower subregion. A “main support region” is preferably to mean a region via which a large portion of the operating forces acting on the cutting tool during operation can be supported, and can in particular discharged to a base element. For this purpose, the rear subregion of the fastening region, which is realized as a main support region, is preferably oriented, with respect to a cutting movement direction, roughly orthogonally, that is to say it is preferably pivoted by merely at most 10 degrees, preferentially by at most of 5 degrees, relative to the orthogonal. That the rear subregion has a greater extent is to mean that the rear subregion has a greater extent in the longitudinal extension than the lower subregion. The rear subregion is in its longitudinal direction longer than the lower subregion. The lower subregion is in its longitudinal direction shorter than the rear subregion. By a “cutting movement direction” is preferably a direction to be understood in which a cutting edge of the cutting tool moves during operation. Herein the cutting movement direction is preferably realized as a straight movement component in which the cutting edge would move, as a result of the rotation of the comminuting rotor, at a defined point in time. This allows providing an especially advantageous support surface for operating forces.

It is also proposed that the cutting tool has a fastening hole which extends along a fastening-hole longitudinal axis from a rear side into the cutting tool and has an inner thread for a fastening of a fastening member. A “rear side of the cutting tool” is preferably to mean a side facing away from the cutting edge of the cutting tool. As a result, the cutting tool can be realized in an especially simple manner for a connection to the base element.

Moreover, it is proposed that the fastening region comprises a free surface, which is arranged between the lower subregion and the rear subregion and has an extent of at least 10 mm, preferably at least 15 mm. By a “free surface” is preferably a surface to be understood which in an assembled state does not adjoin a corresponding contact surface of the base element. Preferably, the free surface is non-machined. Preferably, the free surface is formed by two free sub-surfaces, wherein a first free sub-surface is allocated to the rear subregion, and the second free sub-surface is allocated to the lower subregion. The free sub-surfaces are arranged at an angle to one another. The free sub-surfaces are in each case slightly tilted with respect to a corresponding contact surface of the allocated subregion of the fastening region. As a result, the cutting tool can be realized in a particularly cost-effective manner.

Furthermore, a cutting system with the cutting tool according to the invention is proposed, comprising a base element which is configured for a rigid connection to a comminuting rotor and has on a front side a contact region configured such that the cutting tool adjoins with its fastening region at least partly in a form-fitting manner. A “comminuting rotor” is preferably to mean a rotation body to the lateral surface of which preferably a plurality of base elements are connected, via which in each case a cutting tool can be connected. A “cutting system” is preferably to mean a system comprising at least one base element and comprising a cutting tool that can be fastened thereto. A “base element” is preferably to mean an element which is fixedly and rigidly connected to a comminuting rotor and is configured for a connection to a cutting tool that is releasable without destruction. Preferably, a cutting tool may be fastened to the base element, in a manner releasable without destruction, via a screw connection by means of a screw. Preferably, the base element is configured to be rigidly connected to the comminuting rotor by material bonding via a welded connection. A “comminuting rotor” is preferably to mean a rotation body which is configured to be equipped with at least one cutting tool for carrying out a comminuting operation. In an operating state, the comminuting rotor rotates around its longitudinal axis, as a result of which the cutting tool is brought into contact with the material that is to be comminuted. A “longitudinal axis” of the comminuting rotor is in particular to mean a rotational symmetry axis of a geometrical cylinder of smallest volume, which just still encloses the comminuting rotor. The comminuting rotor in particular has a base body which is preferably realized in a rotation-symmetrical manner and to which at least one base element is fastened, preferably in a rotationally fixed manner. Especially advantageously, the base body is at least partly realized as a round tube. Herein the base element may be fastened to the base body in any manner that is deemed expedient by someone skilled in the art, in particular via a screw connection and preferably via an integral implementation. Preferably, the base element is welded with the base body.

A “contact region” is preferably to mean a region adjoined at least partly by a cutting tool with its fastening region, wherein the fastening region is preferably realized as a fastening hollow, and forces, in particular operating forces, are discharged from the cutting tool into the base element via the fastening region. The contact region is realized substantially so as to correspond to the fastening region. Preferably, the contact region has intended slight differences from the fastening region of the cutting tool such that, in an assembled state, a tensioning is created between the contact region and the fastening region, i.e. the cutting tool and the base element. Preferably, the cutting tool adjoins the contact region over a large portion of its fastening region, or over the entire longitudinal extension of the fastening region. In principle, it is also conceivable that the cutting tool adjoins the contact region only in subregions that make up less than 50% of the longitudinal extension of the fastening region. This advantageously allows providing a system by which cutting tools can be attached to a comminuting rotor in a particularly simple and secure manner via a base element.

Moreover, it is proposed that the contact region comprises a first subregion which, in an assembled state of a cutting tool, is partly engaged around by the rear subregion of the fastening region of the cutting tool. This allows realizing the contact region for the connection of the cutting tool in an especially advantageous manner.

It is further proposed that the lower subregion of the fastening region of the cutting tool is arranged at least substantially tangentially, i. e. only slightly tilted, with respect to a circumference of the comminuting rotor. This allows the lower subregion to be oriented in an especially advantageous manner, wherein in particular the main loads are supported via the other subregion.

It is moreover proposed that the contact region comprises a first subregion to be contacted by the rear subregion of the fastening region of the cutting tool and comprises a second subregion to be contacted by the lower subregion of the fastening region of the cutting tool, said subregions including an angle with one another which differs by at least 0.25 degrees from an angle included by the rear subregion of the fastening region of the cutting tool and the lower subregion of the fastening region of the cutting tool. As a result, the contact region of the base element and the fastening region of the cutting tool can be matched to one another in an especially advantageous manner, so that the cutting tool and the base element are tensioned with one another in a screw connection and an especially favorable connection can thus be created.

The cutting tool according to the invention and the cutting system shall not be limited to the above-described application and implementation. In particular, in order to fulfill a functionality that is described here, the cutting tool according to the invention and the cutting system may have a number of individual elements, components and units that differs from a number mentioned here.

### DRAWINGS

Further advantages will become apparent from the following description of the drawings. Two exemplary embodiments of the invention are shown in the drawings. The drawing, the description and the claims contain numerous features in combination. Someone skilled in the art will purposefully also consider the features individually and will find further expedient combinations.

In the drawings:

FIG. 1 shows a schematic illustration of a comminuting rotor according to the invention, with a cutting system according to the invention comprising several base elements and cutting tools fastened thereto,

FIG. 2 shows a schematic view of a cutting system comprising a base element and the cutting tool that is fastened, in particular screwed, thereto,

FIG. 3 shows an exploded illustration with the base element, the cutting tool and a fastening screw, FIG. 4 shows a schematic side view of a cutting tool that is screwed to the base element by means of a fastening member,

FIG. 5 shows a sectional view through a middle plane of the cutting tool that is screwed to the base element by means of a fastening member,

FIG. 6 shows a schematic view of the cutting tool with its fastening region for a connection to the base element, comprising a first, rear subregion and a second, lower subregion,

FIG. 7 shows a schematic view of the cutting tool from below, onto the lower subregion,

FIG. 8 shows a schematic view of the cutting tool from the front onto the cutting edge,

FIG. 9 shows a schematic sectional view through a middle plane of the cutting tool,

FIG. 10 shows a sectional view through a lower subregion of a fastening region of the cutting tool,

FIG. 11 shows a schematic view of a base element with its receiving region for a connection of a cutting tool,

FIG. 12 shows a schematic plan view of the base element with its receiving region for a connection of a cutting tool,

FIG. 13 shows a schematic side view of the base element with its receiving region for a connection of a cutting tool,

FIG. 14 shows a schematic view of a cutting tool according to the invention in a second exemplary embodiment, with a cutting edge that is realized as a hard metal cutting edge and is arranged in a cutting-edge receptacle,

FIG. 15 shows a schematic side view of the cutting tool in the second exemplary embodiment, and

FIG. 16 shows a schematic sectional view of the cutting tool in the second exemplary embodiment.

### DESCRIPTION OF THE EXEMPLARY EMBODIMENTS

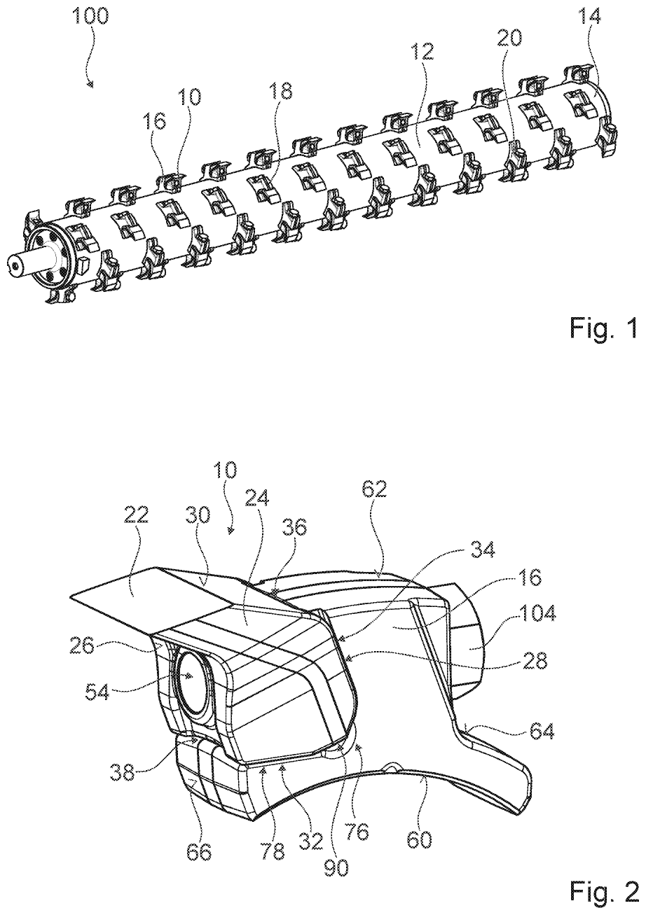

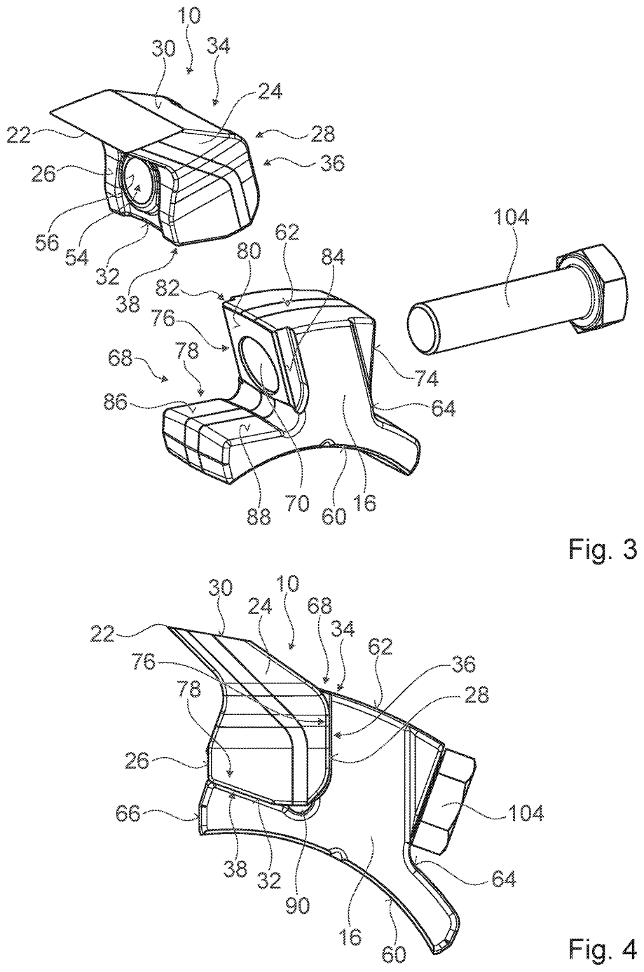

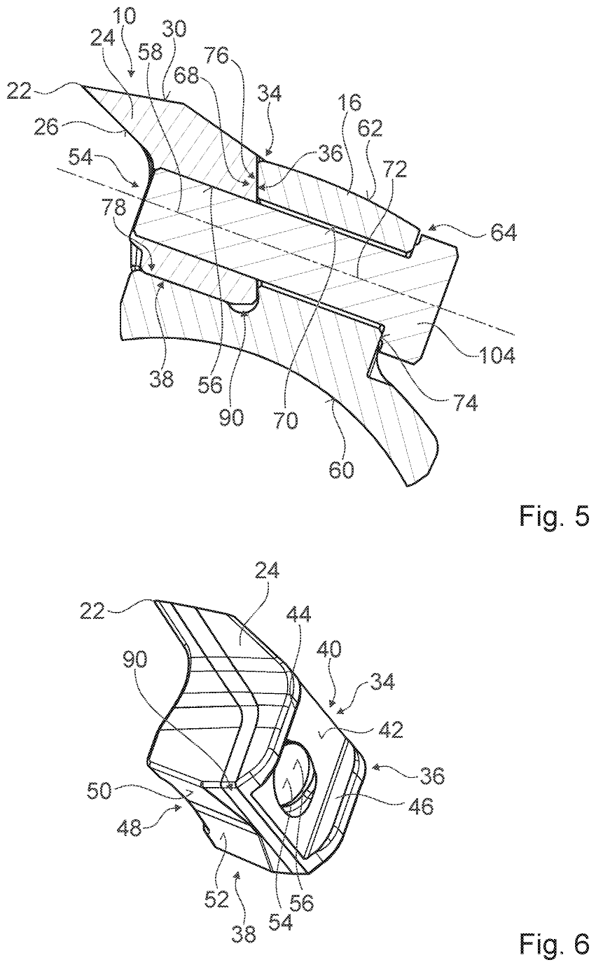

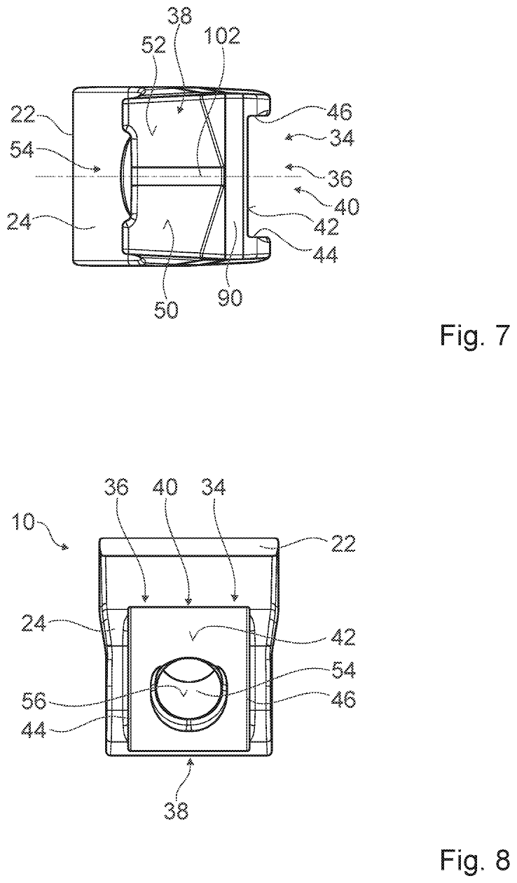

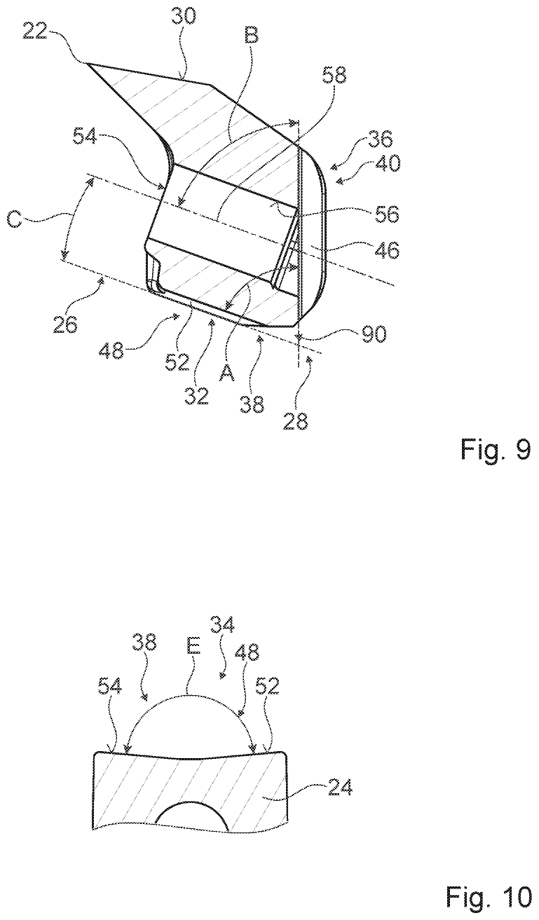

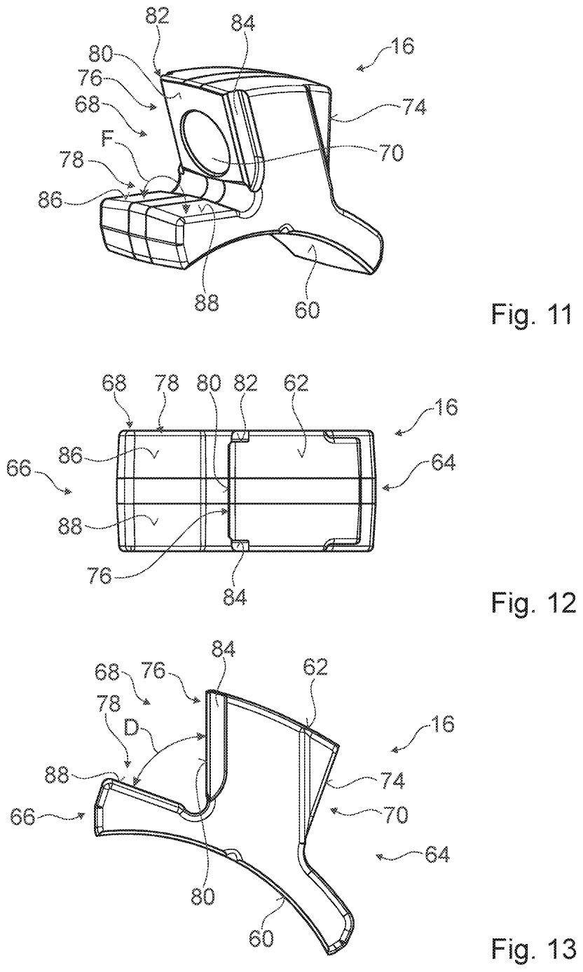

FIGS. 1 to 13 show a first exemplary embodiment of a cutting tool 10 according to the invention of a cutting system 100 according to the invention. FIG. 1 shows a comminuting rotor 12 according to the invention, comprising a cutting system 100 according to the invention with several cutting tools 10 according to the invention. Such comminuting rotors 12 are in particular put to use in attachment tools for commercial vehicles, in particular, for a mulching and/or shredding. The comminuting rotor 12 is configured for a comminution of wood and/or soil. The comminuting rotor 12 comprises a base body 14. The base body 14 is realized having a roller shape. The base body 14 is realized having a tube shape. The base body 14 is preferably made of steel. The cutting system 100 comprises a plurality of base elements 16, 18, 20. The base elements 16, 18, 20 are fixedly fastened to the comminuting rotor 12. The base elements 16, 18, 20 are preferably connected to the base body 14 of the comminuting rotor 12 by material bonding. The base elements 16, 18, 20 are preferably welded with the comminuting rotor 12. Preferably, the base elements 16, 18, 20 are rigidly connected to a jacket of the comminuting rotor 12 via a welded connection.

On each base element 16, 18, 20 of the cutting system 100 a cutting tool 10 is connected. The cutting tools 10 are in each case fixedly connected to the comminuting rotor 12 via the base elements 16, 18, 20. In the following, only one cutting tool 10 and the respective base element 16 will be described in detail. The further cutting tools 10 are preferably realized identically. In principle, however, it would also be conceivable that at least some of the further cutting tools 10 would be realized partly differently.

In FIG. 2 an isometric view is shown of the base element 16 with the cutting tool 10 fastened thereto. The cutting tool 10 has a base body 24. The base body 24 is made of a metal. The base body 24 is preferably realized as a forged part. The cutting tool 10 has a cutting edge 22. The cutting edge 22 preferably has a width of 40 mm. In principle, it would be conceivable that the cutting edge 22 has a width that is between 20 mm and 70 mm. The cutting edge 22 is preferably realized integrally with the base body 24 of the cutting tool 10. The cutting edge 22 is realized together with the base body 24. The cutting tool 10 forms the cutting edge 22 and the base body 24 together as a forged tool. In principle, it would also be conceivable that the cutting edge 22 is realized as a separate cutting edge, for example a separate hard metal cutting edge, which is connected to the base body 24. For this purpose, the base body 24 would form a cutting-edge receptacle, wherein the cutting edge 22 would be fixedly connected in the cutting-edge receptacle of the base body 24. The cutting edge 22 is fastened to the cutting-edge receptacle in a loss-proof manner. The separately realized cutting edge 22 would preferably be connected in the cutting-edge receptacle of the base body 24 by material bonding via a soldered connection. In principle, it would also be conceivable that the separately realized cutting edge 22 is fastened to the cutting-edge receptacle, in a different loss-proof manner, in a force-fitting, form-fitting and/or material-bonding manner. In principle, it would also be conceivable that the base body 24, or the base body 24 together with the cutting edge 22, is realized as a milled component. It is preferably conceivable that a forged part which forms the base body 24 and/or the cutting edge 22 is re-machined in a machining step by milling, drilling and/or hardening.

The base body 24 of the cutting tool 10 has a front side 26. In an assembled state, the front side 26 faces away from the base element 16. The base body 24 of the cutting tool 10 has a rear side 28. In an assembled state, the rear side 28 of the cutting tool 10 faces towards the respective base element 16. The base body 24 of the cutting tool 10 has an upper side 30. In an assembled state, the upper side 30 of the cutting tool 10 faces away from the base element 16, and in particular from the comminuting rotor 12. The base body 24 of the cutting tool 10 has an underside 32. In an assembled state, the underside 32 of the cutting tool 10 faces towards the base element 16, and in particular towards the comminuting rotor 12. The cutting edge 22 of the cutting tool 10 is attached to the front side 26. The cutting edge 22 is attached to the front side 26 of the cutting tool 10 in an upper region which adjoins the upper side 30. The cutting edge 22 may protrude beyond the upper side 32 of the base body 24. The base body 24 has on its upper side 30 a length of 54 mm to 34 mm, preferably in particular 44 mm, between the rear side 28 and the cutting edge 22. The base body 24 has on its underside 32 a length of 24 mm to 44 mm, preferably in particular 34 mm, between the rear side 28 and the front side 26. The base body 24 has on its front side 26 a height of 30 mm to 50 mm, preferably in particular 40 mm, between the underside 32 and the cutting edge 22.

The cutting tool 10 comprises a fastening region 34. The cutting tool 10 can be fastened to one of the base elements 16, 18, 20 via the fastening region 34. The fastening region 34 is realized as a fastening hollow. In the following, only a connection of the cutting tool 10 to the one base element 16 will be described, wherein a connection of the cutting tool 10 to the other base elements 18, 20 is brought about in an equivalent manner. The cutting tool 10 can be coupled to the base element 16 via the fastening region 34. In an assembled state, the cutting tool 10 is supported on the base element 16 via the fastening region 34. The cutting tool 10 is coupled via the fastening region 34 in a form-fitting manner, at least in two directions, preferably in three or four directions. As a result of the form-fitting support via the fastening region 34, the cutting tool 10 can be supported on the base element 16 in two, preferably in three or four directions.

The fastening region 34 preferably extends centrally on the rear side 28 and the underside 32 of the cutting tool 10. The fastening region 34 is preferably introduced in the cutting tool 10 centrally in a transverse direction. The fastening region 34 is thus arranged centrally, in particular between lateral walls of the cutting tool 10. The fastening region 34 preferably has a middle plane 102. The middle plane 102 of the fastening region 34 extends in the cutting tool 10 centrally in the transverse direction. The fastening region 34 preferably extends in a transverse direction substantially over the entire width of the rear side 28. Preferably, the fastening region 34 likewise extends in a transverse direction substantially over the entire width of the underside 32. In principle, it would also be conceivable that on the rear side 28 and/or on the underside 32 the fastening region 34 does not extend over an entire width in the transverse direction. It would in such a case be conceivable that side regions of the rear side 28 and/or of the underside 32 are in each case at least partly free from the fastening region 34.

The fastening region 34 preferably extends over the rear side 28 and the underside 32 of the base body 24. The fastening region 34 is realized in an elongate manner. The fastening region 34 of the cutting tool 10 has a longitudinal extension. The longitudinal extension of the fastening region 34 runs in the middle plane 102 of the fastening region 34 from an upper end of the fastening region 34 in the rear side 28 as far as a lower end of the fastening region 34 in the underside 32. The fastening region 34 comprises a rear subregion 36. The rear subregion 36 forms a first subregion of the fastening region 34. The rear subregion 36 is arranged on the rear side 28 of the base body 24. The fastening region 34 comprises a lower subregion 38. The lower subregion 38 forms a second subregion of the fastening region 34. The lower subregion 38 is arranged on the underside 32 of the base body 24. The two subregions 36, 38 are oriented at an angle to one another. The fastening region 34 is thus also realized in an angled manner along its longitudinal extension. The fastening region 34 has a bend in its longitudinal extension. The lower subregion 38 and the rear subregion 36 of the fastening region 34 include an angle A of 20 degrees to 120 degrees with one another. In the exemplary embodiment shown, the angle A included by the lower subregion 38 and the rear subregion 36 with one another is, by way of example, 70.25 degrees.

The rear subregion 36 of the fastening region 34 is realized as a main support region. The rear subregion 36 has a greater extent than the lower subregion 38 of the fastening region 34. Via the rear subregion 36, preferably a large portion of the forces that occur during operation are supported on the respective base element 16 and thus on the comminuting rotor 12. The rear subregion has a longitudinal extent of 25 mm to 40 mm, preferably of 32 mm. The lower subregion 38 has a longitudinal extent of 10 mm to 30 mm, preferably in particular of 20 mm.

The rear subregion 36 is formed by a groove 40. The groove 40 that forms the rear subregion 36 has a planar contact surface 42 and lateral flanks 44, 46. The flanks 44, 46 are configured, in an assembled state, to engage around a correspondingly realized contact region of a base element 16, 18, 20. The lateral flanks enclose an angle of 70 degrees to 110 degrees with the planar contact surface 42. By way of example, in the exemplary embodiment shown, the angle between the flanks 44, 46 and the planar contact surface 42 is advantageously in each case 90 degrees. The lateral flanks 44, 46 project by at least 5 mm beyond the planar contact surface 42 of the rear subregion 36. The lateral flanks 44, 46 preferably project by between 3 mm and 7 mm beyond the planar contact surface 42. The lateral flanks 44, 46 are configured to engage around and to laterally adjoin the corresponding base element 16, 18, 20. The lateral flanks 44, 46 are configured, in an assembled state, to fix the cutting tool 10 in a transverse direction by laterally engaging around the base element 16, 18, 10. By the lateral flanks 44, 46, a form-fitting support of the cutting tool 10 is provided in the transverse direction on the respective base element 16, 18, 20.

The fastening region 34 is in its lower subregion 38 at least partly realized as a wedge-shaped groove 48. Preferably, the entire lower subregion 38 is realized as a wedge-shaped groove 48. In principle, however, it is also conceivable that only a portion, for example less than 50%, of the lower subregion 38 is realized as a wedge-shaped groove 48. Preferably, it is also conceivable that the lower subregion 38 is realized as a wedge-shaped groove 48 in several regions that are spaced apart from each other. The lower subregion 38 has, at least in the one region in which it is realized as a wedge-shaped groove 48, two sidewalls 50, 52 which are arranged at an angle E to each other. The sidewalls 50, 52 of the lower subregion 38 are oriented obliquely with respect to each other. The sidewalls 50, 52 extend over an entire longitudinal extension of the lower subregion 38 of the fastening region 36. However, the sidewalls 50, 52 preferably do not extend over the entire underside 32 of the base body 24. In principle, several pairs of sidewalls 50, 52 are also conceivable, which are arranged spaced apart from one another and form the lower subregion 38 as a wedge-shaped groove 48 only region-wise. The sidewalls 50, 52 include an angle E with one another that is between 150 degrees and 180 degrees. Preferably, in the exemplary embodiment shown, the sidewalls 50, 52 exemplarily include an angle E of 169.5 degrees with one another. Preferably, the lower subregion 38 of the base body 24, which is embodied as a forged part, is realized at least substantially in a non-machined manner. Preferably, the sidewalls 50, 52 of the lower subregion 38, which is realized as a wedge-shaped groove 48, may be non-machined. In an alternative implementation, the lower subregion 38 could be realized as a planar surface, thus having no angle between sidewalls 50, 52.

The cutting tool 10 has a fastening hole 54. The fastening hole 54 is configured for a connection of the cutting tool 10 to the base element 16. The fastening hole 54 is configured for receiving a fastening member 104 for a connection of the cutting tool 10 to the base element 16. The fastening hole 54 is introduced in the rear side 28 of the cutting tool 10 in the base body 24. The fastening hole 54 extends from the rear side 28 into the base body 24. The fastening hole 54 is realized as a through-hole. The fastening hole 54 comprises an inner thread 56. For a fastening of the cutting tool 10, a fastening member 104, for example a fastening member 104 realized as a screw, can be screwed into the fastening hole 54, and can thus be fixedly connected via the inner thread 56. The fastening member 104 is preferably embodied as a screw. For example, the fastening member 104 may be embodied as an M16 or M18 screw. The fastening hole 54 is introduced in the fastening region 34, in particular in a rear subregion 36 of the fastening region 34, in particular in the planar contact surface 42. In principle, it would herein also be conceivable that the fastening hole 54 does not have an inner thread. In such a case, the fastening hole 54 realized as a through-hole would be configured only such that for a connection to the base element 16 a fastening member 104 is passed through, wherein a screw head or a nut would adjoin on the front side 26 in order to connect the cutting tool 10 to the base element 16. In principle, it would also be conceivable that the fastening hole 54 would be realized as a blind hole which does not extend from the rear side 28 as far as the front side 26. The fastening hole 54 has a fastening-hole longitudinal axis 58. The fastening-hole longitudinal axis 58 is realized as a middle axis of the fastening hole 54. The fastening hole 54 extends along the fastening-hole longitudinal axis 58.

The rear subregion 36 of the fastening region 34 includes an angle B with the fastening-hole longitudinal axis 58. The lower subregion 38 of the fastening region 34 includes an angle C with the fastening-hole longitudinal axis 58. The angle B included by the rear subregion 36 of the fastening region 34 and the fastening-hole longitudinal axis 58 differs from the angle C included by the lower subregion 38 of the fastening region 34 and the fastening-hole longitudinal axis 58. The rear subregion 36 of the fastening region 34 includes an angle B with the fastening-hole longitudinal axis 58 that is between 40 degrees and 100 degrees. Preferably, in the exemplary embodiment shown, the angle B included by the rear subregion 36 of the fastening region 34 and the fastening-hole longitudinal axis 58 is, by way of example, 70.5 degrees. The lower subregion 38 of the fastening region 34 includes an angle C with the fastening-hole longitudinal axis 58 that is between 0 degrees and 3 degrees. Preferably, the angle C included by the lower subregion 38 of the fastening region 34 and the fastening-hole longitudinal axis 58 is less than 1 degree, in particular 0.25 degrees. Slight deviations from the precise angle specifications of the different angles are conceivable here, in particular due to manufacturing tolerances.

The fastening region 34 comprises a free surface 90, which is arranged between the lower subregion 38 and the rear subregion 36. The free surface 90 preferably extends over the entire width of the base body 24. The free surface 90 has an extent of 25 mm to 15 mm in the longitudinal direction of the fastening region 34. Preferably, in the exemplary embodiment shown the free surface 90 has an extent of, by way of example, 17 mm in the longitudinal direction of the fastening region 34. The free surface 90 is not configured for a contact with the respective base element 16, 18, 20. In an assembled state of the cutting tool 10, the free surface 90 is not in contact with the base element 16. The free surface 90 is preferably not machined. The free surface 90 is formed by two free sub-surfaces, wherein a first free sub-surface is allocated to the rear subregion 36, and the second free sub-surface is allocated to the lower subregion 38. The free sub-surfaces are arranged at an angle to one another. The free sub-surfaces are in each case slightly tilted with respect to the allocated subregion 36, 38 of the fastening region 34.

The base element 16 is configured for a rigid connection to the comminuting rotor 12. Preferably, the base element 16 is fixedly and rigidly welded with the base body 14 of the comminuting rotor 12 via a welded connection. The base element 16 is preferably realized as an elongate element. The base element 16 has an underside 60. The underside 60 faces towards the comminuting rotor 12. With its underside 60, the base element 16 is welded on so as to face towards the base body 14 of the comminuting rotor 12. Preferably, for this purpose, the underside 60 of the base element 16 has a shape corresponding to an outer contour of the base body 14. The base element 16 has an upper side 62, which faces away from the comminuting rotor 12. The base element 16 has a rear side 64. The rear side 64 of the base element 16 points counter to a working-rotation direction of the comminuting rotor 12. The rear side 64 of the base element 16 is thus oriented counter to the cutting movement direction. The base element 16 has a front side 66. The front side 66 of the base element 16 points in a working-rotation direction of the comminuting rotor 12. The base element 16 is preferably made of a metal. The base element 16 is preferably realized as a forged part.

The base element 16 has a contact region 68 on its front side 66. The contact region 68 is configured for the cutting tool 10 adjoining with its fastening region 34 at least partly in a form-fitting manner. The contact region 68 is configured for a form-fitting connection of the cutting tool 10. In an assembled state, the cutting tool 10 is connected to the base element 16, and thus to the comminuting rotor 12, via the contact region 68. The contact region 68 is realized so as to correspond to the fastening region 34 of the cutting tool 10. In an assembled state, the cutting tool 10 adjoins the contact region 68, in a form-fitting manner, at least in three, preferably in four directions. In an assembled state, the cutting tool 10 is connected with its fastening region 34 to the contact region 68 of the base element 16 in a form-fitting manner.

The base element 16 has a fastening hole 70. The fastening hole 70 has a fastening-hole longitudinal axis 72. In an assembled state, the fastening-hole longitudinal axis 72 of the fastening hole 70 is oriented coaxially with the fastening-hole longitudinal axis 58 of the fastening hole 54 of the cutting tool 10. The fastening hole 70 is configured for a fixing of the cutting tool 10 in the contact region 68. The fastening hole 70 is configured for a fastening member 104 to be passed through. The fastening hole 70 is realized as a through-hole. The fastening hole 70 extends from the front side 66 as far as the rear side 64 of the base element 16. The fastening hole 70 is arranged in a region of the contact region 68. The fastening hole 70 is realized as a simple through-hole, which in particular does not have an inner thread. The base element 16 has a support surface 74 on its rear side 64 in the region of the fastening hole 70. A fastening member 104 realized as a screw for a fastening of the cutting tool 10 can be supported on the support surface 74 with its screw head. In principle, it would also be conceivable that the fastening hole 70 of the base element 16 is realized as a blind hole having an inner thread and the fastening hole 54 of the cutting tool 10 is realized as a through-hole. For a fastening of the cutting tool 10 to the base element 16, a fastening member 104 realized as a screw would be guided from the front side 26 of the cutting tool 10 through the fastening hole 54 of the cutting tool 10 realized as a through-hole and would be screwed into the fastening hole 70 of the base element 16, which in that case has an inner thread.

The contact region 68 of the base element 16 is realized substantially in an L-shape. The contact region 68 of the base element 16 is realized in an angled fashion. The contact region 68 has a first, rear subregion 76. The first, rear subregion 76 of the contact region 68 of the base element 16 is realized so as to correspond to the rear subregion 38 of the fastening region 34 of the cutting tool 10. The contact region 68 has a second, lower subregion 78. The second, lower subregion 78 of the contact region 68 of the base element 16 is realized so as to correspond to the lower subregion 38 of the fastening region 34 of the cutting tool 10. The two subregions 76, 78 are arranged at an angle to one another. The subregions 76, 78 include an angle D of preferably 70 degrees with one another. The angle D is preferably between 20 degrees and 120 degrees. The angle D, which is included by the first subregion 76 for the contact of the rear subregion 36 of the fastening region 34 of the cutting tool 10 and the second subregion 78 for the contact of the lower subregion 38 of the fastening region 34 of the cutting tool 10 with one another, differs from the angle A, which is included by the subregions 38, 40 of the fastening region 36 with one another. The angle D differs from the angle A. The angle D differs from the angle A by at least 0.25 degrees. Preferably, the angle D differs from the angle A by between 0.1 degrees and 0.5 degrees. Due to the slight difference of the angle D from the angle A, the cutting tool 10 is advantageously tensioned with its fastening region 34 in the contact region 68 of the base element 16.

In an assembled state of a cutting tool 10, the first, rear subregion 76 of the contact region 68 is engaged around by the rear subregion 36 of the fastening region 34 of the cutting tool 10. In an assembled state, the rear subregion 36 of the fastening region 34 of the cutting tool 10 engages around the first, rear subregion 76 of the contact region 68 of the base element 16. The first, rear subregion 76 has a main contact surface 80. The main contact surface 80 is realized as a planar surface. The main contact surface 80 is realized so as to correspond to the contact surface 42 of the groove 40 that forms the rear subregion 36 of the fastening region 34 of the cutting tool 10. The main contact surface 80 is arranged on the front side 66 of the base element 16. The first, rear subregion 76 has two lateral support surfaces 82, 84. The lateral support surfaces 82, 84 of the first, rear subregion 76 of the contact region 76 are realized so as to correspond to the flanks 44, 46 of the groove 40 that forms the rear subregion 36 of the fastening region 34. The lateral support surfaces 82, 84 are introduced in side walls of the base element 16. The lateral support surfaces 82, 84 are configured to be engaged around by the rear subregion 36 of the fastening region 34 of the cutting tool 10, in particular by the flanks 44, 46 of the groove 42. In an assembled state, the flanks 44, 46 of the groove 42 preferably adjoin the lateral support surfaces 82, 84 in a form-fitting manner. The lateral support surfaces 82, 84 preferably each have the same angle with the main contact surface 80 as the flanks 44, 46 have with the contact surface 42 of the groove 40.

The second, lower subregion 78 of the contact region 68 is oriented upwards, away from the underside 60 of the base element 16. The second, lower subregion 78 of the contact region 68 is arranged at a lower end of the first, rear subregion 76. Viewed counter to the cutting movement direction, the second subregion 78 of the contact region 68 is arranged in front of the first, rear subregion 76. The second subregion 78 of the contact region 68 is realized as a wedge-shaped elevation. The second subregion 78 has a first side surface 86 and a second side surface 88, which are oriented at an angle to one another. The side surfaces 86, 88 of the second subregion 78 are oriented away from each other. The two side surfaces 86, 88 are in each case oriented laterally outwards. Between the two side surfaces 86, 88, a planar intermediate surface is arranged, which in an assembled state does not adjoin the fastening region 34, in particular the lower subregion 38 of the cutting tool 10. The intermediate surface arranged between the side surfaces is not configured for a contact with the fastening region 34 of the cutting tool 10. At least the intermediate surface is not machined. The two side surfaces 86, 88 include an angle F with one another. The two side surfaces 88, 86 include an angle F with one another that is between 150 degrees and 180 degrees. The angle F, which is included by the two side surfaces 86, 88 of the second subregion 78 of the contact region 68 with one another, is preferably realized so as to be by between 0.1 degrees and 0.5 degrees, preferably by 0.25 degrees, greater than the angle E, which is included by the sidewalls 50, 52 which the wedge-shaped groove 48 of the lower subregion 38 of the fastening region 34 form with one another. As a result, during assembly, the sidewalls 50, 52, which form the wedge-shaped groove 48 of the second subregion 38 of the fastening region 34, are tensioned with the side surfaces 86, 88 of the second subregion 78 of the contact region 68. In this way, the cutting tool 10 can be mounted on the base element 16 in a particularly secure fashion.

The lower subregion 78 of the contact region 68 is oriented substantially tangentially to a circumference of the comminuting rotor 12. As a result, the second, lower subregion 38 of the fastening region 34 of the cutting tool 10 is likewise arranged at least substantially tangentially to a circumference of the comminuting rotor 12.

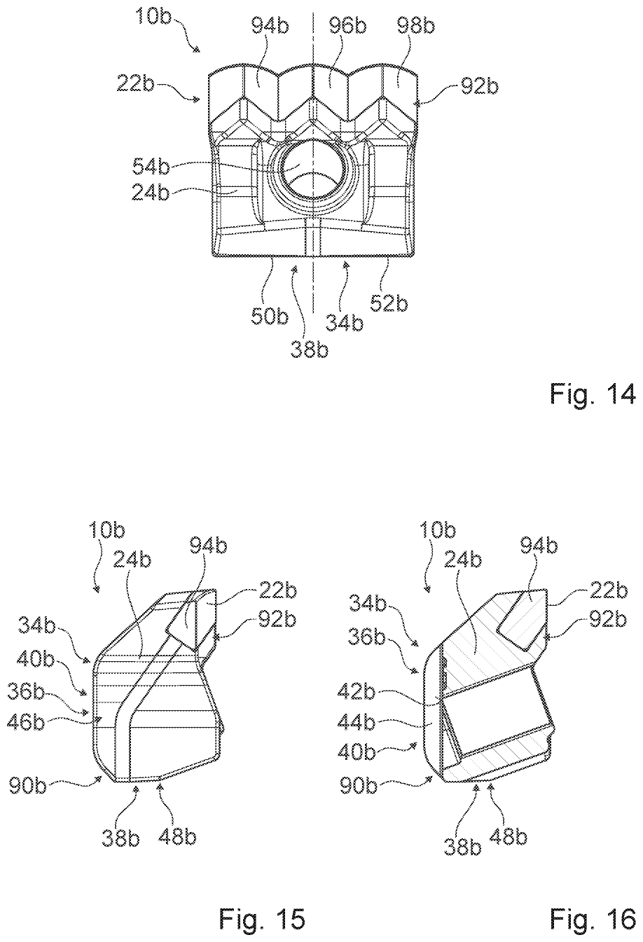

In FIGS. 14 to 16 a further exemplary embodiment of the invention is shown. The following descriptions and the drawings are limited substantially to the differences between the exemplary embodiments, wherein regarding components having the same denomination, in particular regarding components with the same reference numerals, reference may in principle also be made to the drawings and/or the description of the other exemplary embodiments, in particular of FIGS. 1 to 13. In order to distinguish between the exemplary embodiments, the letter b has been added to the reference numerals in the exemplary embodiment of FIGS. 14 to 16.

In FIGS. 14 to 16, a second exemplary embodiment of a cutting tool 10b according to the invention is illustrated. Like the cutting tool of the first exemplary embodiment of FIGS. 1 to 13, the cutting tool 10 b is part of a cutting system, which is not illustrated here in detail, and is configured to be fastened to a base element, which is not illustrated here either. The cutting system, and in particular the base element for the cutting tool 10b, are realized in the same way as in the first exemplary embodiment and will therefore not be described again here. A description of the cutting system and of the base element may be gathered from the description of the first exemplary embodiment.

The cutting tool 10b has a base body 24b. The base body 24b is made of a metal. The base body 24b is preferably realized as a forged part. The cutting tool 10b has a cutting edge 22b. The cutting edge 22b is fixedly attached to the cutting tool 10b. Preferably, the cutting edge 22b is connected to the cutting tool 10b by material bonding. In this exemplary embodiment, the cutting edge 22b is realized as a cutting edge made of a hardened metal. The cutting edge 22b is realized as a hard-metal cutting edge. The base body 24b forms a cutting-edge receptacle 92b. The cutting-edge receptacle 92b is realized as a groove. The cutting-edge receptacle 92b is realized as a groove extending in the transverse direction. The groove that forms the cutting-edge receptacle 92b preferably has a U-shaped cross section. The cutting edge 22b is fixedly connected in the cutting-edge receptacle 92b of the base body 24b. The cutting edge 22b is fastened to the cutting-edge receptacle 92b in a loss-proof manner. The cutting edge 22b is preferably connected in the cutting-edge receptacle 92b of the base body 24b by material bonding via a soldered connection. In principle, it would also be conceivable that the cutting edge 22b is fastened to the cutting-edge receptacle 92b in a different loss-proof manner, in a force-fitting, form-fitting and/or material-bonding manner. The base body 24b and the cutting edge 22b together form the cutting tool 10b. The cutting edge 22b is formed by several individual cutting teeth 94b, 96b, 98b. In the exemplary embodiment shown, the cutting edge 22b is formed by three individual cutting teeth 94b, 96b, 98b, which are arranged side by side in the cutting-edge receptacle 92b, that is to say they are connected in the cutting-edge receptacle by material bonding. The cutting teeth 94b, 96b, 98b are made of a hard metal. By way of example, the cutting teeth 94b, 96b, 98b are here realized identically. The cutting teeth 94b, 96b, 98b can be realized in different manners depending on the field of application. In principle, a different number of cutting teeth 94b, 96b, 98b is also conceivable.

The cutting tool 10b comprises a fastening region 34b. The fastening region 34b is realized as a fastening hollow. In an assembled state, the cutting tool 10b is supported on a base element via the fastening region 34b. The cutting tool 10b is coupled via the fastening region 34b at least in two directions, preferably in three or four directions, in a form-fitting manner. As a result of the form-fitting support via the fastening region 34b, the cutting tool 10b can be supported on the base element in two directions, preferably in three or four directions. The fastening region 34b preferably extends over the rear side 28b and the underside 32b of the base body 24b. The fastening region 34b is realized in an elongate manner. The fastening region 34b comprises a rear subregion 36b. The rear subregion 36b realizes a first subregion of the fastening region 34b. The rear subregion 36b is arranged on the rear side 28b of the base body 24b. The fastening region 34b comprises a lower subregion 38b. The lower subregion 38b realizes a second subregion of the fastening region 34b. The lower subregion 38b is arranged on the underside 32b of the base body 24b. The two subregions 36b, 38b are oriented at an angle to one another. The fastening region 34b is thus realized so as to be angled along its longitudinal extension.

The rear subregion 36b of the fastening region 34b is realized as a main support region. The rear subregion 36b is realized as a groove 40b. The groove 40b that forms the rear subregion 36b has a planar contact surface 42b and lateral flanks 44b, 46b. The flanks 44b, 46b are configured, in an assembled state, to engage around a correspondingly realized contact region of a base element. By the lateral flanks 44b, 46b, a form-fitting support of the cutting tool 10b on the respective base element is provided in the transverse direction.

The fastening region 34b is in its lower subregion 38b at least partly realized as a wedge-shaped groove 48b. Preferably, the entire lower subregion 38b is realized as a wedge-shaped groove 48b. The lower subregion 38b has, at least in the one region in which it is realized as a wedge-shaped groove 48b, two sidewalls 50b, 52b, which are arranged at an angle E to each other. The sidewalls 50b, 52b of the lower subregion 38b are oriented obliquely with respect to each other.

The cutting tool 10b has a fastening hole 54b. The fastening hole 54b is configured for a connection of the cutting tool 10b to the base element. The fastening hole 54b is configured for receiving a fastening member 104b for a connection of the cutting tool 10b to the base element. The fastening region 34b comprises a free surface 90b, which is arranged between the lower subregion 38b and the rear subregion 36b.

1. A cutting tool for a comminuting rotor in particular for a comminution of wood and/or soil, the cutting tool having a base body and having at least one cutting edge and at least one fastening region that is formed by the base body and is preferably realized at least partly as a fastening hollow, the fastening region comprising a lower subregion and a rear subregion which are oriented at an angle to one another, wherein the rear subregion is formed by a groove having a flat contact surface and lateral flanks which are configured, in an assembled state, to engage around a correspondingly realized contact region.

2. The cutting tool according to claim 1, wherein the lateral flanks each have an angle of 70 degrees to 110 degrees, preferably of 90 degrees, with the planar contact surface.

3. The cutting tool according to claim 1, wherein the lower subregion and the rear subregion of the fastening region include an angle A of 20 degrees to 120 degrees, preferably of 70.25 degrees, with one another.

4. The cutting tool according to claim 1, further having a fastening-hole longitudinal axis wherein the rear subregion includes an angle B with the fastening-hole longitudinal axis that is between 40 degrees and 100 degrees, and is preferably 70.5 degrees.

5. The cutting tool according to claim 1, further having a fastening-hole longitudinal axis, wherein the lower subregion has an angle C of less than 3 degrees, preferably of less than 1 degree, with respect to the fastening-hole longitudinal axis.

6. The cutting tool according to claim 1, wherein the lower subregion is realized in a V-shaped manner and has an angle E that is between 150 degrees and 180 degrees, and is preferably 169.5 degrees.

7. The cutting tool according to claim 1, wherein the base body is realized as a forged part, wherein the lower subregion is at least substantially non-machined.

8. The cutting tool according to claim 1, wherein the rear subregion is realized as a main support region, which has a greater extent than the lower subregion.

9. The cutting tool according to claim 1, further comprising a fastening hole which extends along a fastening-hole longitudinal axis from a rear side into the base body and which has an inner thread for a fastening of a fastening member.

10. The cutting tool according to claim 1, wherein the fastening region comprises a free surface which is arranged between the lower subregion and the rear subregion and has an extent of at least 10 mm.

11. A cutting system with a cutting tool according to claim 1, the cutting system comprising a base element which is configured for a rigid connection to a comminuting rotor and has on a front side a contact region that is configured such that the cutting tool adjoins with its fastening region at least partly in a form-fitting manner.

12. The cutting system according to claim 11, wherein the contact region comprises a first subregion which, in an assembled state of a cutting tool is partly engaged around by the rear subregion of the fastening region of the cutting tool.

13. The cutting system according to claim 11, wherein the lower subregion of the fastening region of the cutting tool is arranged at least substantially tangentially to a circumference of the comminuting rotor.

14. The cutting system according to claim 11, wherein the contact region of the base element comprises a first subregion to be contacted by the rear subregion of the fastening region of the cutting tool, and comprises a second subregion to be contacted by the lower subregion of the fastening region of the cutting tool, said subregions including an angle D with one another which differs by at least 0.25 degrees from an angle A included by the rear subregion of the fastening region of the cutting tool and the lower subregion of the fastening region of the cutting tool.
